(19) United States
(12) Patent Application Publication
(10) Pub. No.: US 2026/0064120 A1
(43) Pub. Date: Mar. 5, 2026

(54) ABSOLUTE LOCALIZATION USING OPTICAL FLOW MAPS

(71) Applicant: Wing Aviation LLC, Palo Alto, CA (US)

(72) Inventor: Ali Shoeb, San Rafael, CA (US)

(21) Appl. No.: 18/819,968

(22) Filed: Aug. 29, 2024

(51) Int. Cl. G05D 1/246; G05D 109/20; G05D 111/10; G06T 7/11; G06T 7/246; G06T 7/73; G06V 20/17

(52) U.S. Cl. CPC G05D 1/2462; G06T 7/11; G06T 7/251; G06T 7/75; G05D 2109/20; G05D 2111/10; G06T 2207/10016; G06T 2207/10028; G06T 2207/10032; G06T 2207/20021; G06V 20/17

(57) ABSTRACT

A technique for localization of an unmanned aerial vehicle (UAV) includes: acquiring aerial images of a terrain below the UAV with an onboard camera system of the UAV while the UAV is flying a mission along a preplanned route over the terrain; generating a current optical flow map based upon image pixel motion between consecutive images in a sequence of the aerial images; comparing the current optical flow map to reference optical flow maps stored onboard the UAV, wherein the reference optical flow maps are precomputed from a model of the terrain along the preplanned route; and determining a position in at least two lateral dimensions based on the comparing.

### TECHNICAL FIELD

This disclosure relates generally to visual-based localization of aerial vehicles, and in particular but not exclusively, relates to absolute localization of unmanned aerial vehicles (UAVs) using optical flow.

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby providing package pick-ups and deliveries almost anywhere.

UAVs may be programmed to autonomously navigate using one or more positioning (localization) modalities. One such modality is a global satellite navigation system (GNSS), such as the Global Positioning System (GPS) in North America, where signals received from satellites are processed in order to determine a position of the UAV. Another such modality is an inertial navigation system, where accelerometers and/or other sensors are used to measure distances traveled by the UAV from a known starting point. Yet another such modality is visual navigation, in which images captured by cameras mounted to the UAV are compared to reference images or map data in order to determine a position of the UAV.

GNSS-based localization is often considered the primary modality for localization. However, at times GNSS-based localization may be unavailable or insufficiently precise. For example, UAVs present several challenges to precise position estimation using GPS, including: (i) the imposition of a GPS-exclusion zone near the surface of the earth within which GPS signals are invalid; (ii) position error introduced by reflections of GPS signals by nearby structures and/or the Earth's surface; (iii) urban canyons or geographical dead zones where GPS signals are blocked, and (iv) dynamic environmental factors including wind gusts that can suddenly affect a UAVs position in three dimensions on or near the timescale for refreshing GPS position data. For at least these reasons, it is desirable for a UAV to be provisioned with redundant localization systems.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1A illustrates operation of an unmanned aerial vehicle (UAV) delivery service that delivers packages into a neighborhood, in accordance with an embodiment of the disclosure.

FIG. 1B illustrates optical flow-based analysis of a terrain below a UAV, in accordance with an embodiment of the disclosure.

FIG. 1C illustrates generation of an optical flow map based upon image pixel motion between consecutive images in a sequence of aerial images, in accordance with an embodiment of the disclosure.

FIG. 1D illustrates the creation of reference optical flow maps precomputed from a terrain model along a preplanned route, in accordance with an embodiment of the disclosure.

FIG. 2 is a functional block diagram illustrating relevant components of a UAV delivery system to provide visual localization using optical flow maps, in accordance with an embodiment of the disclosure.

FIGS. 3A & 3B include a flow chart illustrating a process of absolute localization of a UAV using optical flow maps, in accordance with an embodiment of the disclosure.

FIG. 4A illustrates dividing the terrain along a preplanned route into tiles of a predetermined size, in accordance with an embodiment of the disclosure.

FIG. 4B illustrates candidate paths through a tile that are laterally offset from the preplanned route, in accordance with an embodiment of the disclosure.

FIG. 4C illustrates how optical flow maps can be scaled for candidate paths that are vertically offset from the preplanned route when the UAV is flying straight and level, in accordance with an embodiment of the disclosure.

FIG. 4D illustrates the use of semantic segmentation of the aerial images to mask moving or transitory objects in the optical flow maps, in accordance with an embodiment of the disclosure.

FIG. 5A is a perspective view illustration of a UAV configured for use in a UAV delivery system, in accordance with an embodiment of the disclosure.

FIG. 5B is an underside plan view illustration of the UAV configured for use in the UAV delivery system, in accordance with an embodiment of the disclosure.

### DETAILED DESCRIPTION

Embodiments of a system, apparatus, and method of operation for optical flow based localization of an unmanned aerial vehicle (UAV) are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments disclosed herein provide a fallback or redundant localization mechanism for determining the position of a UAV during a mission. The position may be definable in at least two lateral dimensions (e.g., latitude and longitude), but may also localize the UAV in three dimensions (e.g., latitude, longitude, and altitude). The determined position is relative to the Earth's frame of reference (e.g., geo-position on Earth) and thus often referred to as an “absolute localization” or “absolute position” on Earth. This absolute position is in contrast to a relative position often used in machine vision, which localizes relative to a viewable object perceived within the machine's vision. The localization need not define the position in terms of latitude and longitude, but rather may reference other coordinate schemes, but the localization is ultimately translatable into at least x and y lateral positions on a map of a neighborhood, a city, or otherwise.

Embodiments of the described absolute localization scheme use optical flow image analysis to estimate the position of a UAV. Optical flow analysis is a visual perception technique distinct from stereovision depth perception and semantic analysis. The optical flow based localization described herein may be used to validate another onboard localization systems, supplement the other onboard localization systems, or serve as a fallback localization when another localization system fails or is insufficiently accurate. In some embodiments, the other localization system may be a primary localization system (e.g., GPS) while optical flow may serve as a vision-based redundant or backup localization system. The optical flow based localization described herein is particularly well suited to supplement the onboard localization system(s) of UAVs used in an UAV service supplier, such as an UAV delivery service.

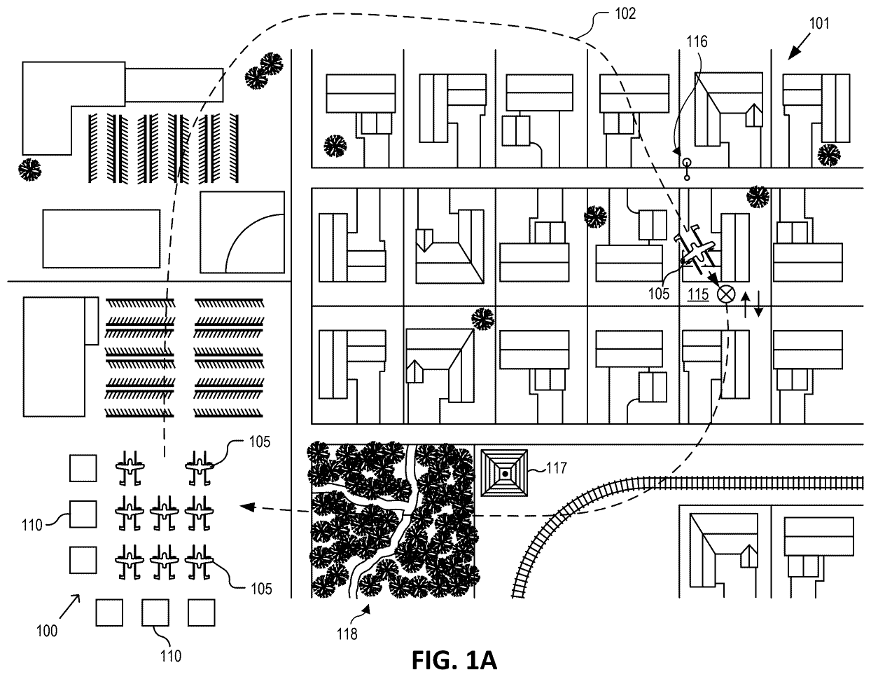

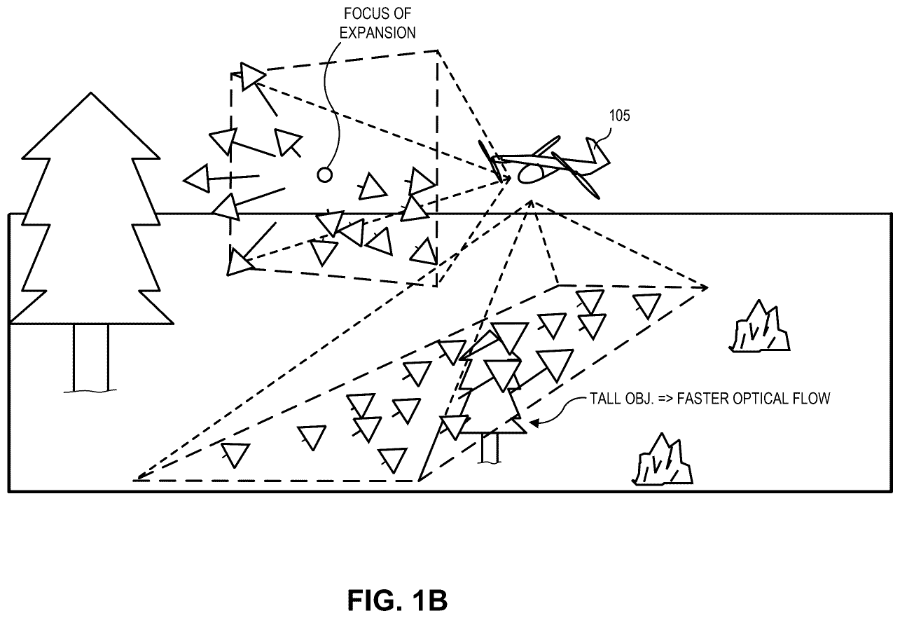

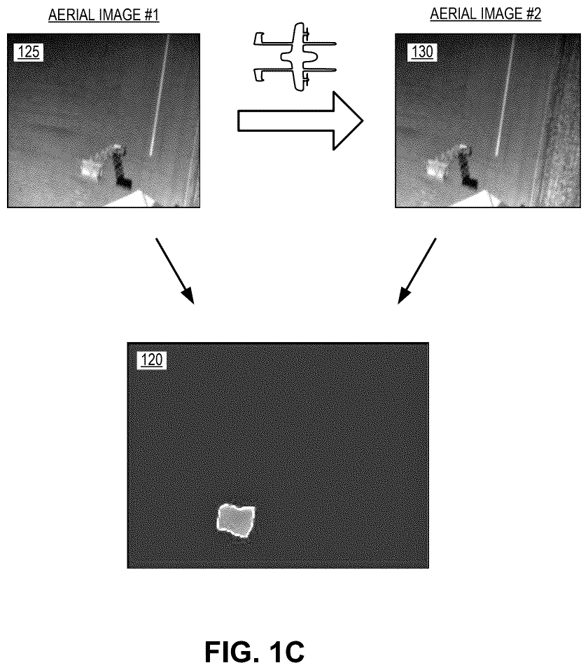

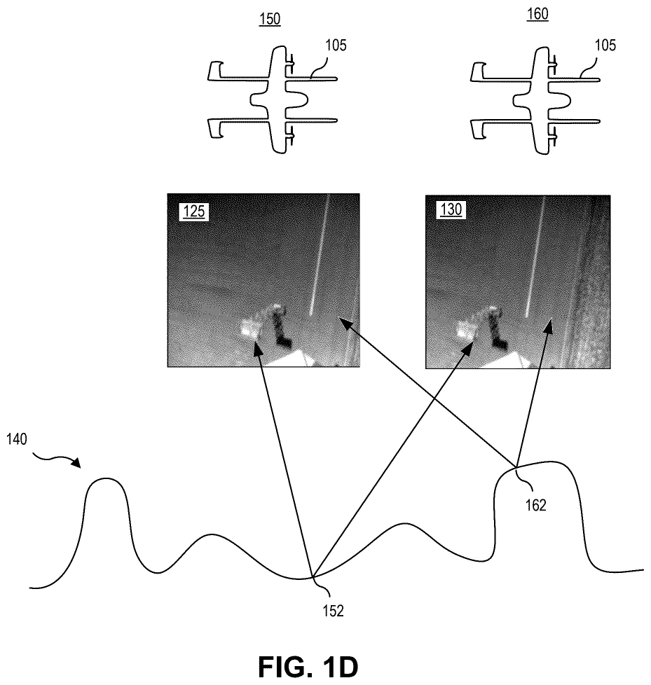

FIG. 1A illustrates operation of a UAV delivery service that delivers packages into a neighborhood 101, in accordance with an embodiment of the disclosure. UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood for waypoint package pickups (not illustrated). An example aerial delivery mission may include multiple mission phases such as takeoff from terminal area 100 with a package for delivery to a destination area 115 (also referred to as a delivery zone, drop zone, or delivery destination), rising to a cruising altitude, and cruising to the customer destination. At destination area 115, UAV 105 descends for package drop-off before once again ascending to a cruise altitude for the return cruise back to terminal area 100.

During the course of a delivery mission, ground-based obstacles are an ever-present hazard—particularly tall slender obstacles such as streetlights 116, telephone poles, radio towers 117, cranes, trees 118, etc. The ability of UAV 105 to accurately and robustly localize itself not only facilitates navigation to its next destination, but also avoidance of mapped obstacles. Accordingly, it is desirable for UAVs 105 to be capable of localization even when GNSS service is unavailable or otherwise insufficient for its needs.

FIG. 1B illustrates an optical flow-based analysis of the environment and terrain below UAV 105 as it flies a mission. Optical flow is the pattern of motion of image pixels representing objects, surfaces, edges, etc. in a visual scene due to relative motion between the observer (e.g., onboard camera system of UAV 105) and a scene (e.g., terrain below UAV 105). Optical flow is the distribution of apparent velocities, or flow velocities, of the image pixels between consecutive image frames in a video stream (e.g., sequence of aerial images). Objects in the image, or image pixels, that appear to move more quickly are estimated to be closer or have a shallower image depth than image pixels that move more slowly. The divergence of these flow velocities can be used to compute a “focus of expansion,” which indicates a direction of heading for UAV 105, a gradient in flow velocities across an imaged object can be used to estimate its height, and the absolute flow velocity of an image pixel can be used to estimate its image depth in the scene (i.e., distance between object and camera). Accordingly, an onboard camera system of UAV 105 that is oriented to look down at the ground below the UAV can be leveraged to estimate distances to objects captured in the images to thereby flag close encounters or localize itself as described below. In embodiments where the onboard camera system is a stereovision camera system, the optical flow analysis can be supplemented with conventional depth perception that leverages parallax to estimate object distances. However, since the distance flown between consecutive aerial images could be on the order 1 m, the depth perception provided by optical flow analysis has the potential for higher accuracy than a stereovision camera having inter-lens distance measurement of a few centimeters. Stereovision depth sensing is typically limited to distances of 20 m, which is well below the cruise altitude of many flight segments during a UAV delivery mission. Finally, semantic analysis that leverages object detection, recognition, and additional knowledge graphs based upon generalized location can further be used to classify clusters of image pixels into objects. Semantic analysis can be leveraged to refine or improve optical flow based localization as discussed below.

All of these localization subsystems may be used in concert to improve the reliability, robustness, and/or precision of the UAV's self-localization. While GNSS based localization may serve as the primary localization system, vision-based localization systems can be called upon when GNSS localization is unavailable or insufficient. For example, a stereovision depth perception may be used with reference to a topographical map along with an altimeter reading to localize UAV 105. A semantic segmentation localization system may be used to analyze real-time images to identifying streets, buildings, and other notable landmarks that may be used to geo-locate UAV 105 with reference to a map including these geographical features. However, a topographical map may not be very useful at low altitudes or over flat geography. A semantic analysis may also be wanting when flying over uniform/low contrast geography lacking notable features (e.g., a forest). In some situations, a real-time optical flow analysis of the terrain below UAV 105 can be compared against a collection of reference optical flow maps to determine the absolute position of UAV 105. The optical flow localization may operate better in certain situations (such as flying over a forest with uniform looking vegetation) where the other vision based localization techniques may struggle.

FIG. 1C illustrates generation of an optical flow map 120 based upon image pixel motion between consecutive images 125 and 130 in a sequence of aerial images, in accordance with an embodiment of the disclosure. Optical flow map 120 is a map of the relative flow velocities of each image pixel moving through the field of view (FOV) of its onboard camera system. Optical flow map 120 is optionally illustrated as a heat map, where image pixels having relatively low flow velocities are associated with darker colors signifying distant objects and image pixels having relative high flow velocities are associated with lighter/brighter colors signifying closer objects. The optical flow patterns/maps generated in real-time by analyzing consecutive images of the onboard camera system are referred to herein as “current optical flow maps. ” These current optical flow maps can be compared against precomputed, reference optical flow patterns/maps that are geo-registered. When a match between a current optical flow map and a reference optical flow map is found, UAV 105 is able to determine its absolute position due to the geo-registration of the reference optical flow maps.

FIG. 1D illustrates the creation of reference optical flow maps precomputed from a model 140 of terrain along a preplanned route of a delivery mission, in accordance with an embodiment of the disclosure. Optical flow based localization may be enabled by first obtaining model 140 of the terrain over a neighborhood, such as neighborhood 101 illustrated in FIG. 1A. In one embodiment, model 140 is a geo-registered point cloud (e.g., 3D point cloud) of the terrain in neighborhood 101. Model 140 may be derived using a variety of techniques. One such technique is to fly a lidar scanning mission over neighborhood 101 prior to commencing UAV delivery operations into neighborhood 101.

Prior to executing the delivery mission illustrated in FIG. 1A, a simulated flight may be flown along preplanned route 102 using model 140. Referring to FIG. 1D, reference optical flow maps may be precomputed for incremental positions (e.g., positions 150 and 160) of UAV 105 along preplanned route 102 using the 3D point cloud model. For example, when UAV 105 flies its delivery mission, UAV 105 acquires aerial image 125 of the terrain below its position 150. Position 150 corresponds to (e.g., is geo-registered to) a position 152 in model 140. Similarly, UAV 105 acquires an aerial image 130 of the terrain below its position 160. Position 160 corresponds to a position 162 in model 140. Just as UAV 105 can measure pixel velocities between consecutive aerial images 125 and 130 to compute a current optical flow map 120, reference optical flow maps may also be computed from the simulated flight over model 140 along the precomputed route 102. These reference optical flow maps may then be uploaded into UAV 105 as part of its mission data. The real-time (i.e., current) optical flow maps computed during the delivery mission may then be matched (e.g., pattern matched) to the reference optical flow maps to provide optical flow based localization. This optical flow based localization is a sort of topographical localization, except that it is not just based off the land geography below UAV 105, but rather the optical flow is looking at pixel flow velocities that arise from all objects in its field of view (FOV) including the ground, buildings, trees, utility poles, etc. This enables optical flow based localization to work over flat geography as long as structures or vegetation provide some elevation differences.

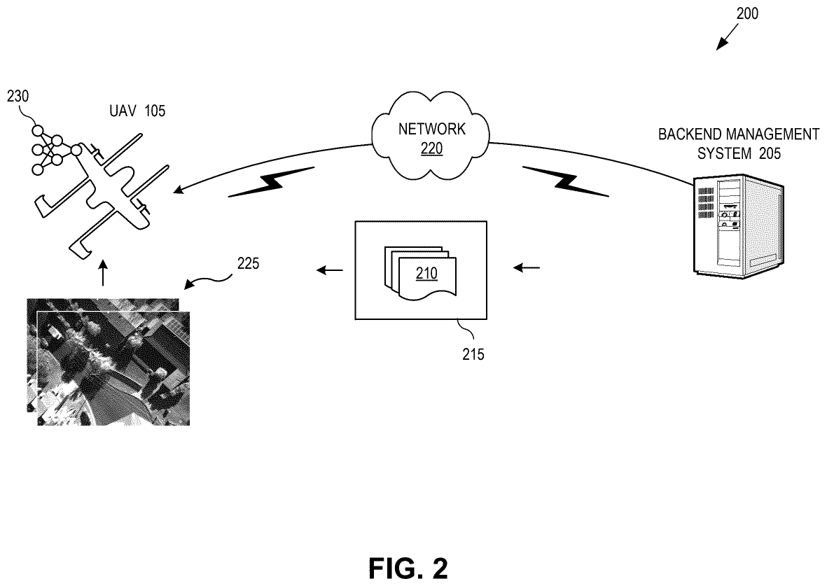

FIG. 2 is a functional block diagram illustrating relevant components of a UAV delivery system 200 that provide backup/redundant localization using optical flow maps, in accordance with an embodiment of the disclosure. System 200 includes a backend management system 205 responsible for acquiring, computing, and maintaining models 140 of the various neighborhoods over which the UAV delivery service is operating. The first time a particular delivery mission is flown between terminal area 100 and a particular delivery destination 115, reference optical flow maps 210 are computed. These reference optical flow maps 210 may then be included in future mission data 215 that is uploaded over network 220 to the UAV 105 selected to fly a delivery mission to destination 115. When UAV 105 flies its delivery mission, it captures aerial images 225 along the way with its onboard camera system and onboard logic 230 computes current optical flow maps based upon the pixel velocities between consecutive images in a sequence of aerial images 225. The current optical flow maps are then compared (e.g., pattern matched) against the geo-registered reference optical flow maps 210 for absolute localization over neighborhood 101 along preplanned route 102.

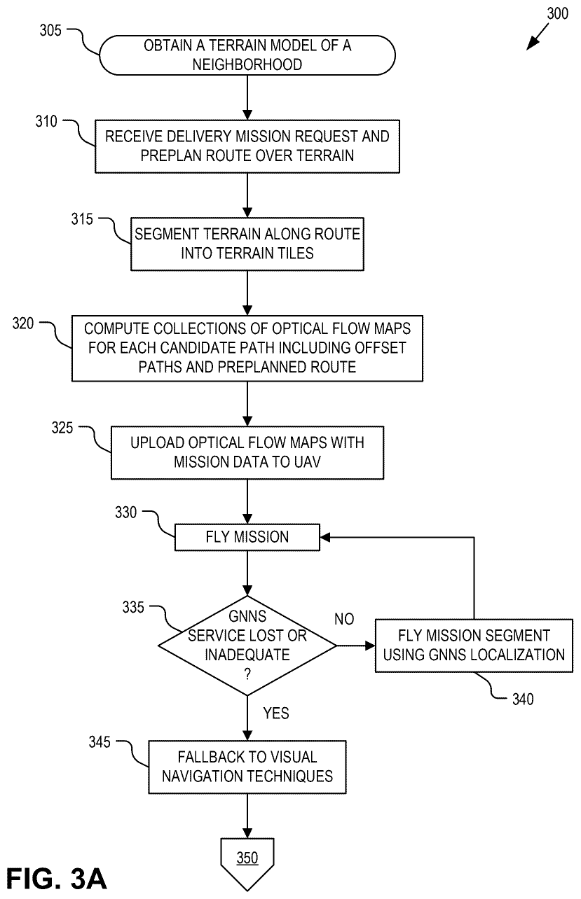

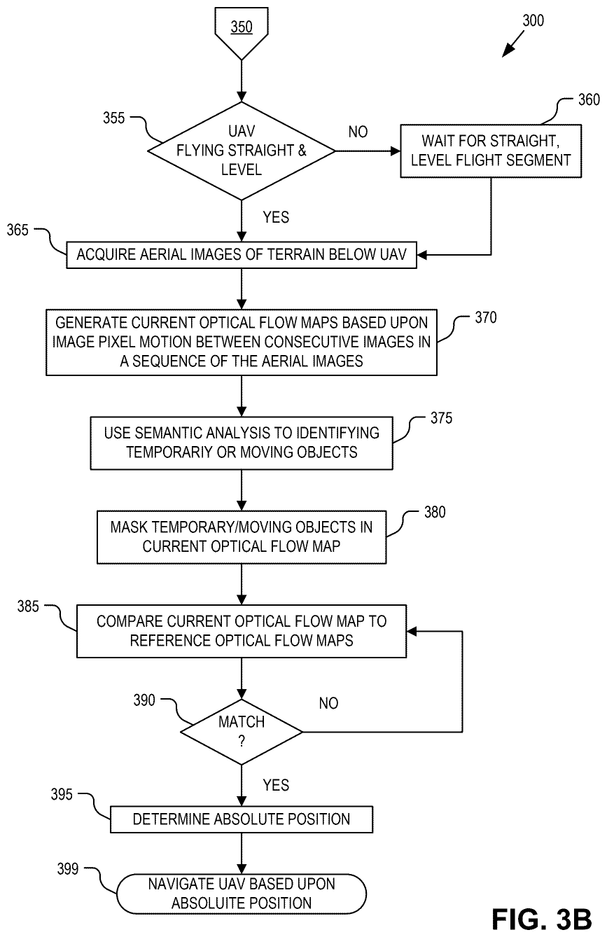

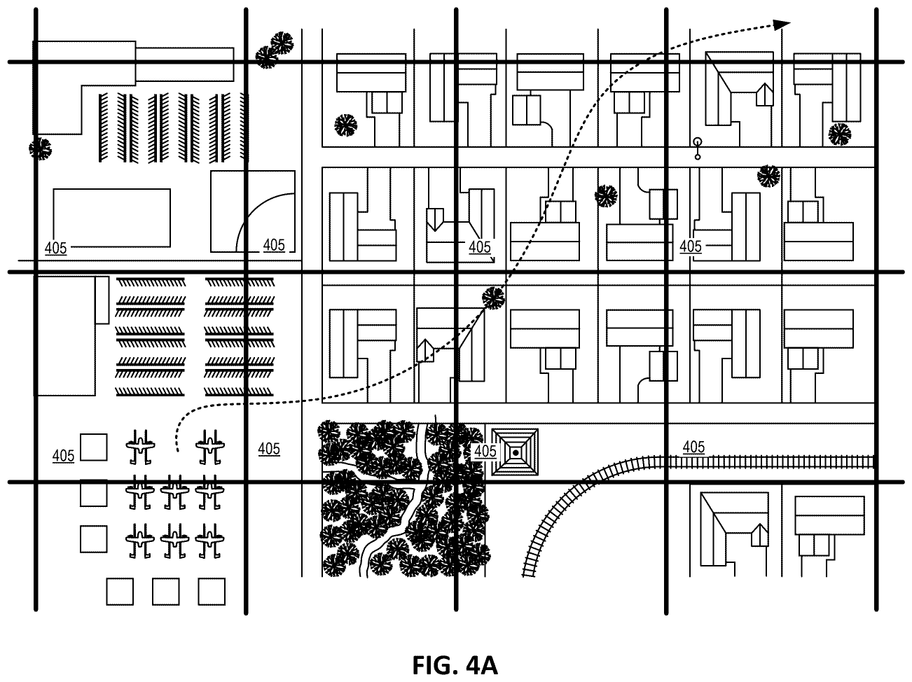

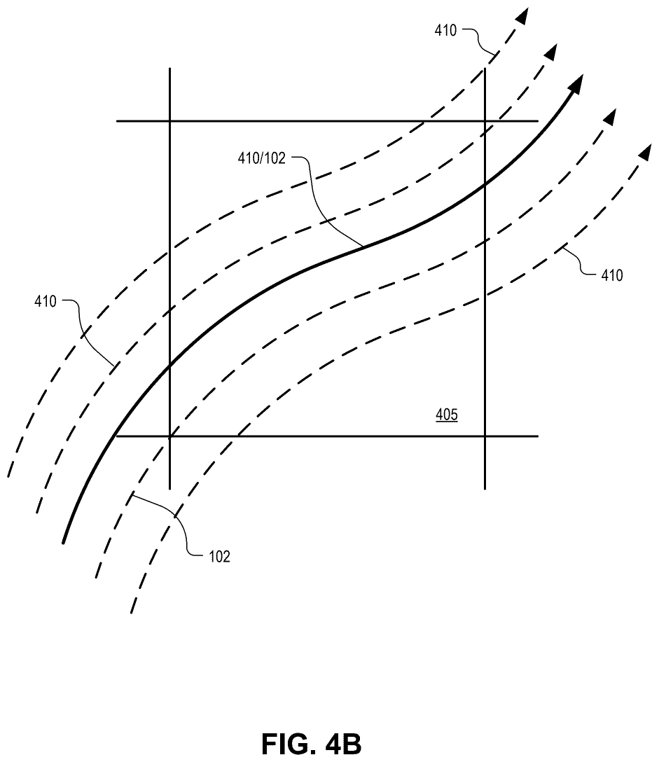

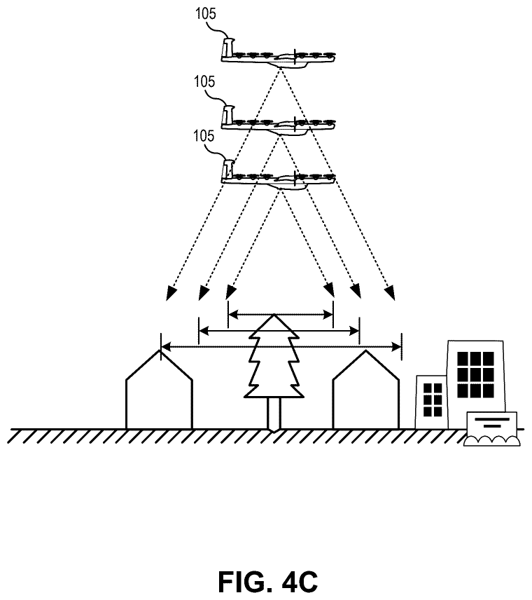

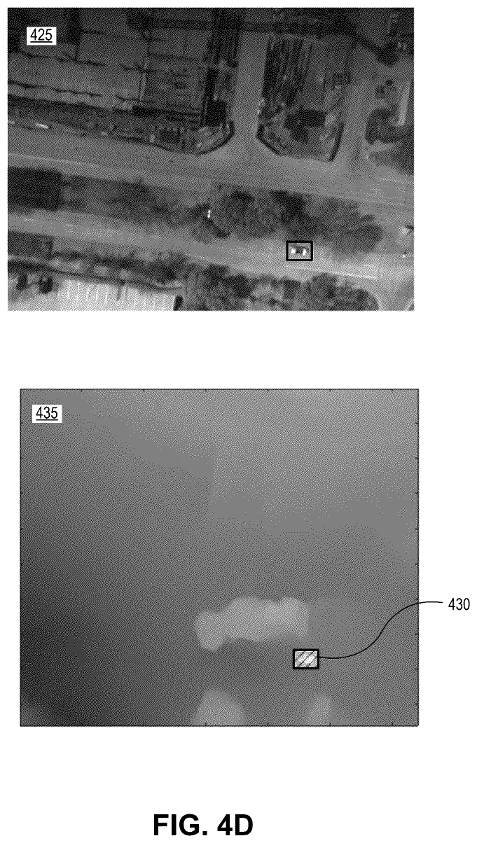

FIGS. 3A & 3B include a flow chart illustrating a process 300 for optical flow based localization of UAVs 105, in accordance with an embodiment of the disclosure. Process 300 is described with reference to FIGS. 2 and 4A to 4D. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

In a process block 305, model 140 of the terrain in neighborhood 101 is obtained. Model 140 may be a geo-registered 3D point cloud obtained from a preliminary lidar scan flown over the terrain of neighborhood 101. Model 140 is stored and maintained by backend management system 205. When a new delivery mission request is received at backend management system 205, a preplanned route is determined extending from terminal area 100 to delivery destination 115 over neighborhood 101 (process block 310).

In a process block 315, the terrain along preplanned route 102 is divided into tiles of a predetermined size (e.g., 60 m×60 m tiles). FIG. 4A illustrates the map of neighborhood 101 divided into tiles 405. Referring to FIG. 4B, for each tile 405 proximate to the preplanned route 102, a collection of reference optical flow maps are computed for each candidate path 410 passing through the given tile 405 (process block 320). Candidate paths 410 align to (e.g., match the geometry or shape of the intended preplanned route 102) in the given tile 405, but are laterally offset. In other words, candidate paths 410 represent what the preplanned path 102 through the given tile 405 would be if preplanned path 102 were laterally offset by an integer multiple n of a specified offset d (e.g., d=1 m, 1.5 m, 2 m, etc.). The candidate paths 410 account for UAV drift in the event UAV 105 drifts from preplanned route 102, it can still localize itself against one of the other candidate paths 410. Accordingly, the term candidate path 410 refers to both the original preplanned route 102 and any of the lateral (or vertical) offset paths. In addition to computing laterally offset candidate paths 410, vertically offset candidate paths may also be computed to account for vertical drift of UAV 105. However, in some embodiments, vertical drift can be accommodated by scaling either the reference or current optical flow maps to accommodate for larger FOVs at higher altitudes and smaller FOVs at lower altitudes (see FIG. 4C). The scaling is simplest when UAV 105 is flying straight and level since rotation of the onboard camera system leads to nonlinear scaling effects in the flow velocities computed by optical flow analysis. When using scaling for vertical drift, collections of reference optical flow maps need not be calculated (or fewer collections calculated with larger vertical displacements) for vertically displaced candidate paths. Accordingly, for each candidate path 410, backend management system 205 computes a collection of optical flow maps in incremental displacements (e.g., 1 m) along the particular candidate path 410. These optical flow maps can then be compared against the current optical flow maps computed in real-time from aerial images 225 captured by UAV 105 during execution of its mission.

Once the collections of optical flow maps for all candidate paths 410 (including offset candidate paths and preplanned route 102) are generated, the reference optical flow maps are uploaded to UAV 105 with its mission data 215 (process block 325) to provision the designated UAV 105 for flying its mission (process block 330). While optical flow localization may be leveraged at any time during a flight mission to supplement other localization techniques, in the illustrated embodiment, optical flow localization operates as a fallback localization service when the primary localization service (e.g., GNSS) is insufficiently precise or inoperative (decision block 335). In other words, when GNSS localization is adequate, UAV 105 determines its absolute position using a GNSS service (e.g., GPS in North America) and navigates on that basis (process block 340). However, when GNSS service is insufficient or inoperative, then localization for navigation falls back to one or more secondary localization services, including optical flow based localization (process block 345). Optical flow based localization may be averaged with the other visual based navigation techniques to increase precision and/or robustness.

Process 300 continues to FIG. 3B via off-page reference 350. In the illustrated embodiment, the optical flow based localization is limited to flight segments where UAV 105 is flying straight and level to reduce complexity associated with vertical drift (decision block 355 & process block 360). In other embodiments, collections of optical flow maps associated with vertically offset candidate paths may also be generated and thus optical flow localization need not be limited to straight and level flight. However, for typical UAV missions, the majority of preplanned route 102 are straight and level flight segments connected by waypoints where direction or altitude changes occur.

While navigating UAV 105 using optical flow based localization, aerial images 225 of the terrain below UAV 105 are acquired using its onboard camera system (process block 365). Aerial images 225 are used to generate current optical flow maps based upon image pixel motion between consecutive images in a sequence of aerial images. (process block 370).

Of course, any pixel motion between consecutive images will affect the optical flow maps, including motion due to cars in transit. Accordingly, semantic analysis can be used to identify moving objects and, even identify temporary objects that are stationary, and filter these objects and their associated artifacts out of the current optical flow maps generated by UAV 105 (process block 375). Referring to FIG. 4D, aerial images 225 (including aerial image 425), may be analyzed using semantic segmentation to identify pixels within aerial image 425 associated with either a moving object or a parked transitory object (e.g., cars, boats, trailers, RVs, etc.). When these types of objects are identified and classified via semantic analysis, the corresponding portion 430 in the current optical flow map 435 is masked (process block 380). The masked current optical flow maps are then compared against reference optical flow maps 210 uploaded with mission data 215 (process block 380). This comparison may include pattern matching, or the use of other comparison algorithms or models. When a match is identified (decision block 390), the absolute position of UAV 105 is then determined based upon the geo-registered nature of reference optical flow maps 210 (process block 395). The absolute position is then used to inform navigation decisions (process block 399).

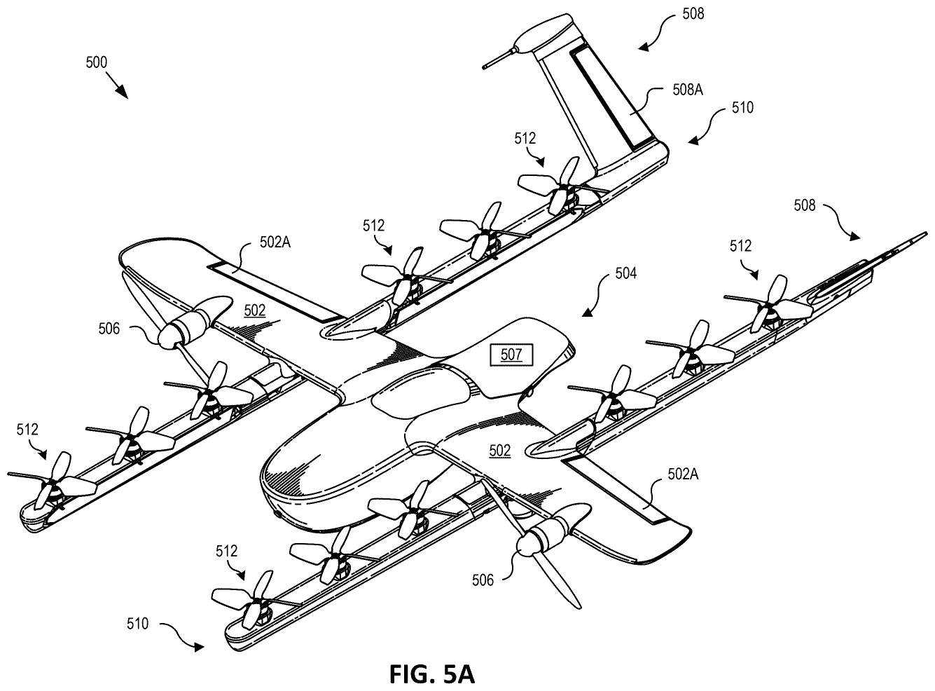

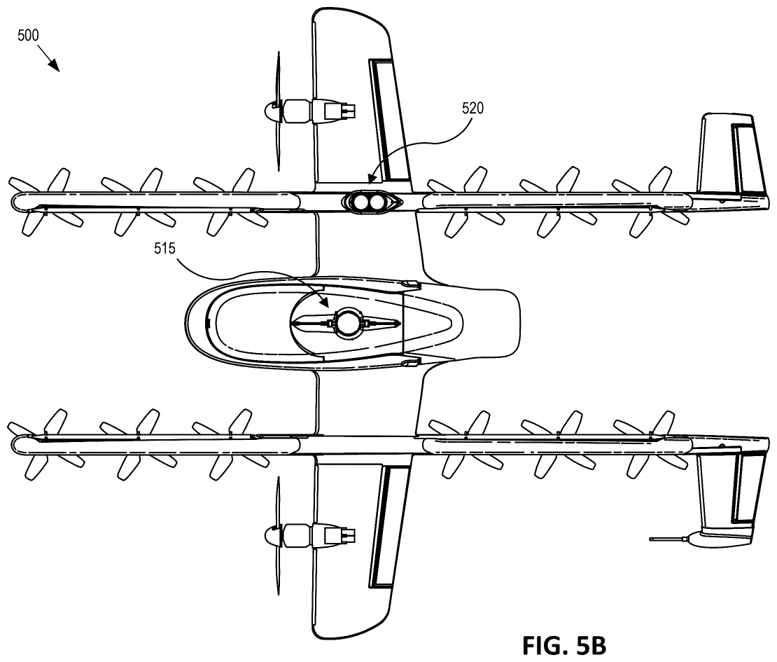

FIGS. 5A and 5B illustrate a UAV 500 that is well-suited for delivery of packages, in accordance with an embodiment of the disclosure. FIG. 5A is a topside perspective view illustration of UAV 500 while FIG. 5B is a bottom side plan view illustration of the same. UAV 500 is one possible implementation of UAVs 105 illustrated in FIG. 1, although other types of UAVs may be implemented for a UAV delivery service as well.

The illustrated embodiment of UAV 500 is a vertical takeoff and landing (VTOL) UAV that includes separate propulsion units 506 and 512 for providing horizontal and vertical propulsion, respectively. UAV 500 is a fixed-wing aerial vehicle, which as the name implies, has a wing assembly 502 that can generate lift based on the wing shape and the vehicle's forward airspeed when propelled horizontally by propulsion units 506. The illustrated embodiment of UAV 500 has an airframe that includes a fuselage 504 and wing assembly 502. In one embodiment, fuselage 504 is modular and includes a battery module, an avionics module, and a mission payload module. These modules are secured together to form the fuselage or main body.

The battery module (e.g., fore portion of fuselage 504) includes a cavity for housing one or more batteries for powering UAV 500. The avionics module (e.g., aft portion of fuselage 504) houses flight control circuitry of UAV 500, which may include a processor and memory, communication electronics and antennas (e.g., cellular transceiver, wifi transceiver, etc.), and various sensors (e.g., GNSS sensor, an inertial measurement unit, a magnetic compass, a radio frequency identifier reader, etc.). Collectively, these functional electronic subsystems for controlling UAV 500, communicating, and sensing the environment may be referred to as a control system 507. The mission payload module (e.g., middle portion of fuselage 504) houses equipment associated with a mission of UAV 500. For example, the mission payload module may include a payload actuator 515 (see FIG. 5B) for holding and releasing an externally attached payload (e.g., package for delivery). In some embodiments, the mission payload module may include camera/sensor equipment (e.g., camera, lenses, radar, lidar, pollution monitoring sensors, weather monitoring sensors, scanners, etc.). In FIG. 5B, an onboard camera 520 (e.g., onboard camera system) is mounted to the underside of UAV 500 to support a computer vision system (e.g., stereoscopic machine vision) for visual triangulation and navigation as well as operate as an optical code scanner for reading visual codes affixed to packages. These visual codes may be associated with or otherwise match to delivery missions and provide the UAV with a handle for accessing destination, delivery, and package validation information. Of course, onboard camera 520 may alternatively be integrated within fuselage 504.

As illustrated, UAV 500 includes horizontal propulsion units 506 positioned on wing assembly 502 for propelling UAV 500 horizontally. UAV 500 further includes two boom assemblies 510 that secure to wing assembly 502. Vertical propulsion units 512 are mounted to boom assemblies 510. Vertical propulsion units 512 providing vertical propulsion. Vertical propulsion units 512 may be used during a hover mode where UAV 500 is descending (e.g., to a delivery zone), ascending (e.g., at initial launch or following a delivery), or maintaining a constant altitude. Stabilizers 508 (or tails) may be included with UAV 500 to control pitch and stabilize the aerial vehicle's yaw (left or right turns) during cruise. In some embodiments, during cruise mode vertical propulsion units 512 are disabled or powered low and during hover mode horizontal propulsion units 506 are disabled or powered low.

During flight, UAV 500 may control the direction and/or speed of its movement by controlling its pitch, roll, yaw, and/or altitude. Thrust from horizontal propulsion units 506 is used to control air speed. For example, the stabilizers 508 may include one or more rudders 508a for controlling the aerial vehicle's yaw, and wing assembly 502 may include elevators for controlling the aerial vehicle's pitch and/or ailerons 502a for controlling the aerial vehicle's roll. While the techniques described herein are particularly well-suited for VTOLs providing an aerial delivery service, it should be appreciated that the techniques described herein are generally applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 5A and 5B illustrate one wing assembly 502, two boom assemblies 510, two horizontal propulsion units 506, and six vertical propulsion units 512 per boom assembly 510, it should be appreciated that other variants of UAV 500 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A machine-readable storage medium includes any mechanism that stores information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer implemented method for localization of an unmanned aerial vehicle (UAV), the computer-implemented method comprising:
acquiring aerial images of a terrain below the UAV with an onboard camera system of the UAV while the UAV is flying a mission along a preplanned route over the terrain;
generating a current optical flow map based upon image pixel motion between consecutive images in a sequence of the aerial images;
comparing the current optical flow map to reference optical flow maps stored onboard the UAV, wherein the reference optical flow maps are precomputed from a model of the terrain along the preplanned route; and
determining a position in at least two lateral dimensions based on the comparing.

2. The computer implemented method of claim 1, wherein the model comprises a geo-registered point cloud of the terrain along the preplanned route.

3. The computer implemented method of claim 2, wherein the geo-registered point cloud is derived from a lidar scan flown over the terrain.

4. The computer implemented method of claim 1, wherein the reference optical flow maps comprise collections of the reference optical flow maps where the collections are associated with candidate paths that each align with the preplanned route or a corresponding one of a plurality of lateral offsets of the preplanned route.

5. The computer implemented method of claim 4, wherein comparing the current optical flow map to the reference optical flow maps comprises:
dividing the terrain along the preplanned route into tiles of a predetermined size; and
searching the reference optical flow maps corresponding to one of the tiles over which the UAV is currently flying to identify one of the candidate paths that matches a current flight path of the UAV.

6. The computer implemented method of claim 4, wherein some of the candidate paths correspond to vertically offsets of the preplanned route.

7. The computer implemented method of claim 4, further comprising:
scaling either the reference or current optical flow maps to identify a candidate path that is vertically offset from the preplanned route.

8. The computer implemented method of claim 1, further comprising:
determining when the UAV is flying straight and level; and
limiting localization of the UAV using the reference optical flow maps when the UAV is flying straight and level.

9. The computer implemented method of claim 1, further comprising:
semantically segmenting the aerial images to identify pixels within the aerial images associated with either moving objects or transitory objects; and
masking any portion of the current optical flow map that aligns with an instance of either the moving objects or the transitory objects.

10. The computer implemented method of claim 1, wherein determining the position based on the comparing comprises a backup localization for the UAV when a global navigation satellite system (GNSS)-based localization is insufficiently precise or inoperative.

11. At least one machine-readable storage medium having instructions stored thereon that, in response to execution by an unmanned aerial vehicle (UAV) delivery system, cause the UAV delivery system to perform operations comprising:
acquiring aerial images of a terrain below a UAV of the UAV delivery system with an onboard camera system of the UAV while the UAV is flying a mission along a preplanned route over the terrain;
generating a current optical flow map based upon image pixel motion between consecutive images in a sequence of the aerial images;
comparing the current optical flow map to reference optical flow maps stored onboard the UAV, wherein the reference optical flow maps are precomputed from a model of the terrain along the preplanned route; and
determining a position in at least two lateral dimensions based on the comparing.

12. The at least one machine-readable storage medium of claim 11, wherein the model comprises a geo-registered point cloud of the terrain along the preplanned route.

13. The at least one machine-readable storage medium of claim 12, wherein the geo-registered point cloud is derived from a lidar scan flown over the terrain.

14. The at least one machine-readable storage medium of claim 11, wherein the reference optical flow maps comprise collections of the reference optical flow maps where the collections are associated with candidate paths that each align with the preplanned route or a corresponding one of a plurality of lateral offsets of the preplanned route.

15. The at least one machine-readable storage medium of claim 14, wherein comparing the current optical flow map to the reference optical flow maps comprises:
dividing the terrain along the preplanned route into tiles of a predetermined size; and
searching the reference optical flow maps corresponding to one of the tiles over which the UAV is currently flying to identify one of the candidate paths that matches a current flight path of the UAV.

16. The at least one machine-readable storage medium of claim 14, wherein some of the candidate paths correspond to vertically offsets of the preplanned route.

17. The at least one machine-readable storage medium of claim 14, wherein the operations further comprise:
scaling either the reference or current optical flow maps to identify a candidate path that is vertically offset from the preplanned route.

18. The at least one machine-readable storage medium of claim 11, wherein the operations further comprise:
determining when the UAV is flying straight and level; and
limiting localization of the UAV using the reference optical flow maps when the UAV is flying straight and level.

19. The at least one machine-readable storage medium of claim 11, wherein the operations further comprise:
semantically segmenting the aerial images to identify pixels within the aerial images associated with either moving objects or transitory objects; and
masking any portion of the current optical flow map that aligns with an instance of either the moving objects or the transitory objects.

20. The at least one machine-readable storage medium of claim 11, wherein determining the position based on the comparing comprises a backup localization for the UAV when a global navigation satellite system (GNSS)-based localization is insufficiently precise or inoperative.
